(19) United States
(12) Patent Application Publication
(10) Pub. No.: US 2015/0222084 A1
(43) Pub. Date: Aug. 6, 2015

(54) Method for Achieving High-Power Solid-State Lasers by Multiple Beams Combination Using Cascaded Compound Laser Resonators

(71) Applicant: JIANGSU ZHONGKESIXIANG LASER TECHNOLOGY CO. LTD, Danyang, Jiangsu (CN)

(72) Inventors: Pengfei Zhao, Danyang (CN); Peichen Lin, Danyang (CN); Xuechun Lin, Danyang (CN); Zhiyong Dong, Danyang (CN)

(21) Appl. No.: 14/417,600

(22) PCT Filed: Sep. 30, 2013
(86) PCT No.: PCT/CN2013/084711

§ 371 Date: Jan. 27, 2015

(30) Foreign Application Priority Data
Jun. 25, 2013 (CN) 201310256188.1

(51) Int. Cl. H01S 3/23; H01S 3/0941; H01S 3/16; H01S 3/02

(52) U.S. Cl. CPC H01S 3/2316; H01S 3/025; H01S 3/0941; H01S 3/1698; H01S 3/2383

(57) ABSTRACT

A method for achieving high-power solid-state lasers by multiple beams combination using cascaded compound laser oscillators, comprising the following steps: 1) Designing a compound resonator to achieve an output beam perpendicular to the axis of oscillation in which a compensating lens is used; 2) Designing beam combination of two independent solid-state lasers in cascaded compound cavities and using 4f optical system to compensate the beam waist separation between two lasers; 3) Based on the first two steps, multiple beams combination of N independent solid-state lasers can be achieved. In the present invention, N output beams emitted from N independent solid-state lasers are completely combined, and the combined beams hold the same waist position, size and divergence along down the same optical axis. Therefore, it can preserve original beam quality with that of individual solid-state lasers.

### BACKGROUND

1. Field

The present invention is related to a method for achieving high-power solid-state lasers by multiple beams combination using cascaded compound laser resonators, which belongs to solid-state laser technology field.

2. Description of Related Art

All-solid-state lasers refer to semiconductor laser pumped solid state lasers, which have the advantages of high efficiency, long life time, good beam quality, and compact structure. Equipments based on the type of laser processing system widely used in automobile, railway, shipbuilding, metallurgy, petrochemical, defense and aerospace and other fields.

High-power solid-state lasers for industrial processing are generally composed of several laser heads in series by resonator or master oscillator power amplifier (MOPA) to obtain high power output, which has the advantages of simple structure, easy to implement. Laser head which is the main component of the solid-state lasers is pumped by dozens to hundreds of diode lasers which are placed along and around the length of the laser rod and pumped perpendicularly to the direction of propagation of the laser radiation. Through reasonable arrangement of pumped diode laser source, the pump-light distribution over the cross section of the laser rod is the center to the outer parabolic gain distribution. Red-shift of wavelength or reduction of output power may occur in the diode lasers working as the pump source. And dozens of diode lasers generally do not change over time synchronization, and individual diode lasers may even be random fail. The random change of the pump-light source will result in the change of uniformity gain distribution and slight displacement of the gain distribution center position. This slight displacement in the series configure will lead to slight angle displacement of the optical axis of the laser, thus affects the stability and reliability of the whole laser system. In industrial applications, stability and reliability are the most important parameters of high-power solid-state lasers working as light source of laser processing system.

### SUMMARY

The objective of the present invention is to overcome the decrease of stability and reliability of the laser systems with increasing operating time, which results from the application of series power amplifying system in high-power solid-state laser. In addition, this invention provides a new power amplifying method-parallel combining multiple laser oscillators, in which output beams of multiple independent all-solid-state lasers are completely combined. In this method the superposed output beams hold the same optical axis, the same waist position and the same divergence. The beam quality of combined laser beams is not worse than the single all-solid-state laser. To achieve the above objective, the present invention of achieving high-power solid-state lasers by multiple beams combination using cascaded compound laser oscillators, comprising the following steps: 1) Designing a compound resonator to achieve an output beam perpendicular to the axis of oscillation in which a compensating lens is used; 2) Designing beam combination of two independent solid-state lasers in cascaded compound cavities and using the 4f optical system to compensate the beam waist separation caused by the optical path difference (OPD) of two lasers; 3) Based on the first two steps, multiple beams combination of N independent solid-state lasers can be achieved; the method comprises:
1) Designing a compound resonator equivalent to plane parallel resonator: designing the 1^{st} solid-state laser whose resonator equivalent to plane parallel resonator, the 1^{st} solid-state laser comprises: three high reflectivity mirrors (11, 12, 13), one coupling output mirror (14), one lens (15), one laser head (16), the said coupling output mirror (14) reflect the laser beam at the angle of 90°±5° with respect to the laser head center axis which changes the limitations of plane-parallel resonator coupling output laser in the laser head center axis direction, achieving N laser beams co-axis superimposed output of N solid-state lasers; using the lenses (n5, n6) to shape the laser beams, N superposed output beams hold the same optical axis, the same waist position and size and the same divergence, and the beam quality of combined laser beams is approximately the same as the single solid-state laser; The reflectivity of the said high reflectivity mirrors (11, 12, 13) is greater than 95% at the laser wavelength at 0° incidence. The said lens (15) composed of one piece or more pieces lenses, with effective focal length between 50-200 mm, is coated by antireflection film which reflectivity less than 1% at laser wavelength at 0° incidence. The said laser head (16) is an assembly containing diode laser pumping source and laser crystal with neodymium or ytterbium doped. Wherein mirror (11) and mirror (12) are placed in parallel, and the coated surface of the said mirrors face to the laser head (16), and the distance between them equals the equivalent plane-parallel resonator physical length, which generally between 200-800 cm, and the distances from the said mirror (11) and mirror (12) respectively to the center plane of laser rod end in laser head (16) are same. The reflectivity of the said coupling output mirror (14) at the laser wavelength between 10% and 50%. The distance L₁₁ between the center of laser spot on the said coupling output mirror (14) and the said high reflectivity mirror (12) is 20-380 mm. The distance L₁₂ between the said lens (15) and the center of laser spot on the said coupling output mirror (14) and the distance L₁₃ between the said high reflectivity mirrors (13) and the said lens (15) relate by: L₁₂=f₁-L₁₁ and L₁₃=f_{1.}
2) Designing parallel combination of two independent solid-state lasers in cascaded compound cavities: the lenses (25, 27) are placed between the laser (1) and (2), and the two lenses (25, 27) composed of one piece or more pieces lenses have the same effective focal length f₂ which between 50 mm-200 mm, and are coated by antireflection film which reflectivity less than 1% at laser wavelength at 0° incidence. We definite that the distance between the axis of the laser rod in the said laser (1) and laser (2) is L₁ and the distance between the said lens (27) and (25) is L₂₆, then we obtain the equations:

L₁=4f₂ [symbol] L₂₆=2f_{2.}
3) Achieving parallel combination of N independent solid-state lasers: place two lenses (n5, n7) between the solid-state lasers ((n−1), n), and the two lenses (n5, n7) consisted by one piece or more pieces lenses have the same effective focal length fₙ which between 30 mm-300 mm. We definite that the distance between the axis of the laser rod in the said laser (n−1) and laser (n) is Lₙ₋₁, the distance between the center of laser spot on the said coupling output mirror (n4) and the said high reflectivity mirror (n2) is Lₙ₁, and the distance between the said lens (n7) and (n5) is Lₙ₆, then we obtain the equations:

Lₙ₋₁=4fₙ

Lₙ₁=Lₙ₋₁₎

Lₙ₆=2f_{n.}

Wherein L(ₙ₋₁₎₁ is the distance between the center of laser spot on the said coupling output mirror ((n−1)4) and the said high reflectivity mirror ((n−1)2);
Wherein n and N are integers, and 1≦n≦N.

From the foregoing description, it will be apparent that the present invention can realize N laser beams co-axis superimposed output of N solid-state lasers and N co-axis laser beams realize to hold the same waist diameter, waist position and divergence, and to amplify the power by a factor of N. And for the coupling output mirrors reflect and transmit laser power at the angle of 45°, the power in resonator of the N lasers couple with each other. Such interaction will cause partly interference effects in the combined laser output beam, and the combined laser beam quality is equal to or better than the beam quality of the single solid-state laser. High-power solid-state lasers achieved by the method have some advantages, such as abilities to achieve modular structure, such as abilities to achieve modular structure, to effectively overcome the whole system instability and unreliability induced by pumping uniformity change of a single laser, and to improve the overall stability and reliability. With this design, it is easy to achieve industrial-graded and modular solid-state lasers with high-power, high reliability, which is easy to maintain.

### BRIEF DESCRIPTION OF THE DRAWINGS

The features and advantages of the present invention will become better understood with regard to the following description and accompanying drawings.

FIG. 1 shows an embodiment of an equivalent resonator according to the present invention.

FIG. 2 shows the reflectivity of the 45° coupling output mirror in the equivalent resonator depicted in FIG. 1 as a function of the reflectivity of the coupling output mirror in the plane-parallel resonator.

FIG. 3 shows an embodiment of parallel combining two independent solid-state laser oscillators according to the present invention.

FIG. 4 shows an embodiment of parallel combining N independent solid-state laser oscillators according to the present invention.

Wherein n is the sequence number of solid-state lasers; n1, n2, and n3 are the high reflectivity mirror; n4 is the coupling output mirror; n6 is the laser head; n5 and n7 are the lens. And n is positive integer, n=1, 2, 3 . . . N.

### DETAILED DESCRIPTION

A method for achieving high-power solid-state lasers by multiple beams combination using cascaded compound laser oscillators, comprising the following steps:
1. Designing a compound resonator equivalent to plane parallel resonator: designing the 1^{st} solid-state laser whose resonator equivalent to plane parallel resonator, the 1^{st} solid-state laser comprises: three high reflectivity mirrors (11, 12, 13), one coupling output mirror (14), one lens (15), one laser head (16), the said coupling output mirror (14) reflect the laser beam at the angle of 90°±5° with respect to the laser head center axis which changes the limitations of plane-parallel resonator coupling output laser in the laser head center axis direction, realizing N laser beams co-axis superimposed output of N solid-state lasers; using the lenses (n5, n6) to shape the laser beams, N superposed output beams hold the same optical axis, the same waist position and size and the same divergence, and the beam quality of combined laser beams is approximately the same as the single all-solid-state laser; The said equivalent resonator is consisted by three high reflectivity mirrors (11, 12, 13). The reflectivity of the said high reflectivity mirrors (11, 12, 13) is greater than 95% at the laser wavelength at 0° incidence. The said lens (15) composed of one piece or more pieces lenses, with effective focal length between 50-200 mm, is coated by antireflection film which reflectivity less than 1% at laser wavelength at 0° incidence. The said laser head (16) is an assembly containing diode laser pumping source and laser crystal with neodymium or ytterbium doped. Wherein mirror (11) and mirror (12) are placed in parallel, and the coated surface of the said mirrors face to the laser head (16), and the distance between them equals the equivalent plane-parallel resonator physical length, which generally between 200-800 cm, and the distances from the said mirror (11) and mirror (12) respectively to the center plane of laser rod end in laser head (16) are same. The reflectivity of the said coupling output mirror (14) at the laser wavelength between 10% and 50%. The distance L₁₁ between the center of laser spot on the said coupling output mirror (14) and the said high reflectivity mirror (12) is 20-380 mm. The distance L₁₂ between the said lens (15) and the center of laser spot on the said coupling output mirror (14) and the distance L₁₃ between the said high reflectivity mirrors (13) and the said lens (15) relate by: L₁₂=f₁-L₁₁ and L₁₃=f₁.
2. Designing parallel combination of two independent solid-state lasers in cascaded compound cavities: the lenses (25, 27) placed between the laser (1) and (2), and the said two lenses (25, 27) composed of one piece or more pieces lenses have the same effective focal length f₂ which between 50 mm-200 mm, and are coated by antireflection film which reflectivity less than 1% at laser wavelength at 0° incidence. We definite that the distance between the axis of the laser rod in the said laser (1) and laser (2) is L₁ and the distance between the said lens (27) and (25) is L₂₆, then we obtain the equations:

L₁=4f₂ [symbol] L₂₆=2f₂.
3. Achieving parallel combination of N independent solid-state lasers: place two lenses (n5, n7) between the solid-state lasers ((n−1), n), and the said two lenses (n5, n7) consisted by one piece or more pieces lenses have the same effective focal length fₙ which between 30 mm-300 mm. We definite that the distance between the axis of the laser rod in the said laser (n−1) and laser (n) is Lₙ₋₁, the distance between the center of laser spot on the said coupling output mirror (n4) and the said high reflectivity mirror (n2) is Lₙ₁ , and the distance between the said lens (n7) and (n5) is Lₙ₆, then we obtain the equations:

Lₙ₋₁=4fₙ

Lₙ₁=L₍ₙ₋₁₎₁

Lₙ₆=2f_{n.}

Wherein L(ₙ₋₁)₁ is the distance between the center of laser spot on the said coupling output mirror ((n−1)4) and the said high reflectivity mirror ((n−1)2);
Wherein n and N are integers, and 1≦n≦N.

### The Embodiment 1

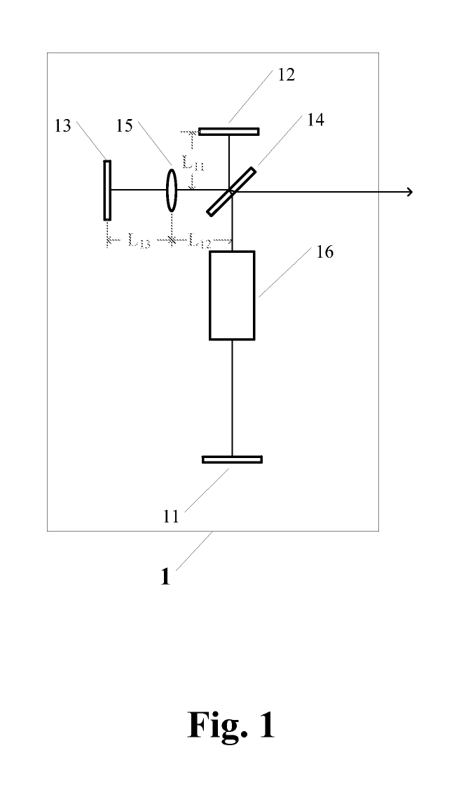

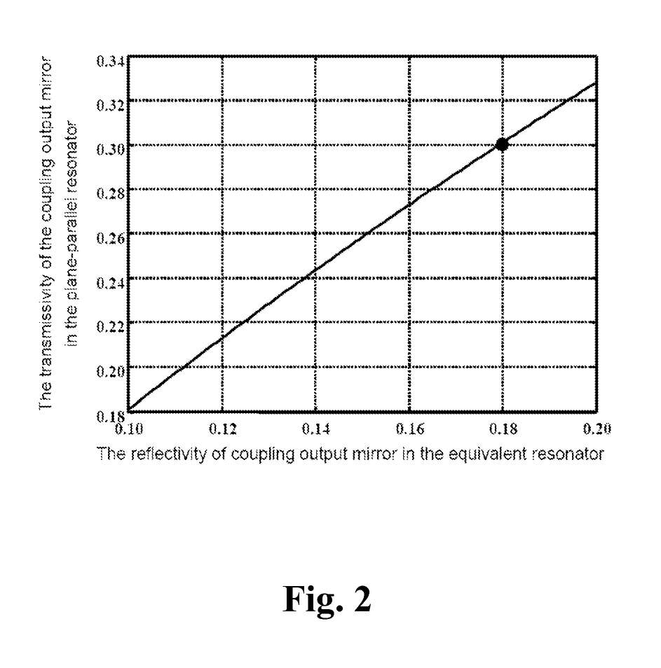

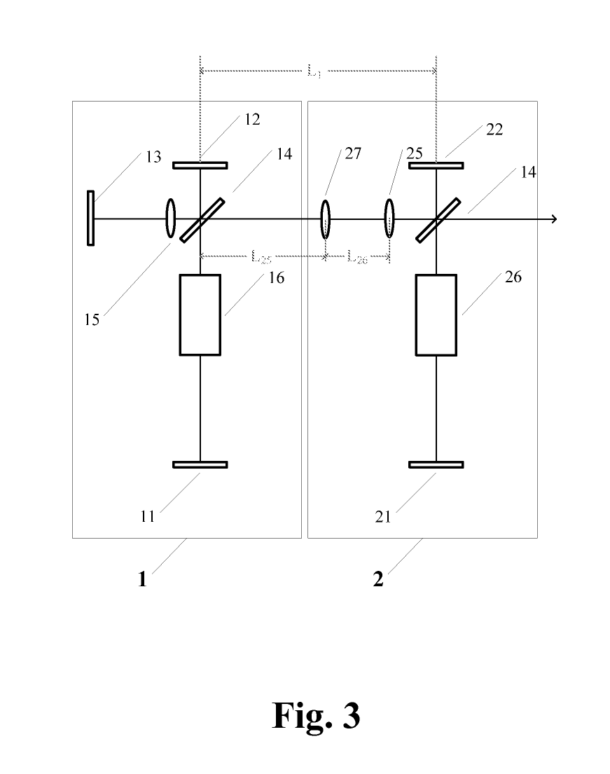

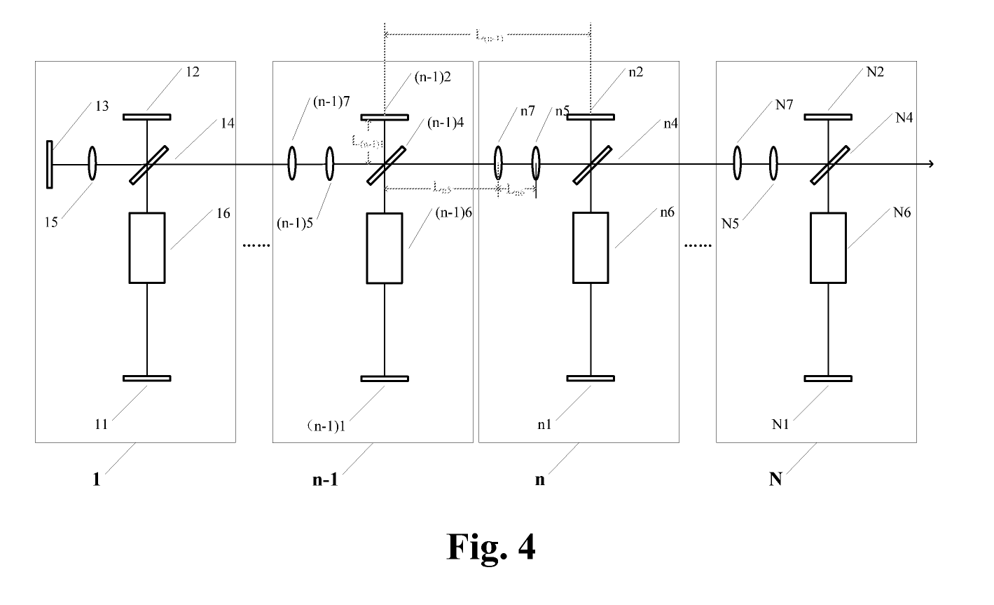

The embodiments of the present invention accord to FIG. 1 to FIG. 4. Applying DPLM40-81 laser head (n6) which is our company homemade, commercial high reflectivity mirrors (n1,n2,n3) whose reflectivity greater than 99.8% at 1064 nm of laser wavelength at 0° incidence, the coupling output mirror (n4) whose reflectivity at 1064 nm of laser wavelength is 18% at 45° incidence, and two lenses (n5, n7) whose effective focal length is 80 mm coated by antireflection film which reflectivity less than 1% at 1064 nm at 0° incidence, we set up apparatus of parallel combining six independent solid-state laser oscillators.
1. Achieving a compound resonator of first all solid state laser (1) equivalent to plane parallel resonator.
   1) Determining the physical length of equivalent resonator. In this case we choose the equivalent plane-parallel resonator length as 600 mm, then the distance between high reflectivity mirrors (11) and (12) is 600 mm.
   2) Determining the parameters of coupling output mirror (14) and lens (15). The angle between the normal to the coupling output mirror and the axis of laser rod which is in laser head (16) is 45°. And the reflectivity of said coupling output mirror is determined by the reflectivity which is 30% of plane-parallel resonator coupling output mirror. According to the relationship showed in FIG. 2, we choose the said coupling output mirror reflectivity as 18%. The focal length f₁ of lens (15), which is a single lens, is 80 mm.
   3) Determining the position parameters of the high reflectivity mirrors (11, 12, 13). According to mathematical relationship in step 1, we choose L₁₁=40 mm, L₁₂=40 mm and L₁₃=80 mm.
2. Achieving parallel combining of two independent solid-state lasers in cascaded compound cavities.
   1) Determining the parameter of lenses (25, 27). Consider the distances between the solid-state lasers used in the parallel combining should not be too long, we choose the focal length of lenses (25, 27), which are a single lens, to be 80 mm.
   2) Determining the position parameter of the two solid-state lasers (1, 2) and lenses (25, 27). According to step 2, we obtain that L₂=320 mm, L₂₆=160 mm, and choose L₂₅=120 mm in the embodiment.
3. Achieving parallel combining of 6 independent solid-state laser oscillators.
   According to step 3, we obtain that the distance Lₙ₆ between the said lenses (n7) and (n5) is 160 mm, the distance Lₙ₋1 between the axis of the laser rod in the said laser (1) and laser (2) is 320 mm, and choose Lₙ₅=120 mm in the embodiment. The embodiments of the present invention described above are only preferred. This invention may be embodied in many different forms and should not be construed as limited to the embodiments set forth herein.

What is claimed is:

1. A method for achieving high-power solid-state lasers by multiple beams combination using cascaded compound laser resonators, comprising the following steps: 1) Designing a compound resonator to achieve an output beam perpendicular to the axis of oscillation in which a compensating lens is used; 2) Designing beam combination of two independent solid-state lasers in cascaded compound cavities and using 4f optical system to compensate the beam waist separation between two lasers; 3) Based on the first two steps, multiple beams combination of N independent solid-state lasers can be achieved. The method comprises:
1) Designing a compound resonator equivalent to plane parallel resonator: designing the 1^{st} solid-state laser whose resonator equivalent to plane parallel resonator, the 1^{st} solid-state laser comprises: three high reflectivity mirrors (11, 12, 13), one coupling output mirror (14), one lens (15), one laser head (16), the said coupling output mirror (14) reflect the laser beam at the angle of 90°±5° with respect to the laser head center axis which changes the limitations of plane-parallel resonator coupling output laser in the laser head center axis direction, achieving N laser beams co-axis superimposed output of N solid-state lasers; using the lenses (n5, n6) to shape the laser beams, N superposed output beams hold the same optical axis, the same waist position and size and the same divergence, and the beam quality of combined laser beams is approximately the same as the single all-solid-state laser;
2) Designing parallel combination of two independent solid-state lasers in cascaded compound cavities: the lenses (25, 27) are placed between the laser (1) and (2), and the said two lenses (25, 27) composed of one piece or more pieces lenses have the same effective focal length f₂ which between 50 mm-200 mm, and are coated by antireflection film which reflectivity less than 1% at laser wavelength at 0° incidence. We definite that the distance between the axis of the laser rod in the said laser (1) and laser (2) is L₁ and the distance between the said lens (27) and (25) is L₂₆, then we obtain the equations:
L₁=4f₂ and L₂₆=2f₂;
3) Achieving parallel combination of N independent solid-state lasers: place two lenses (n5, n7) between the solid-state lasers ((n−1), n), and the two lenses (n5, n7) consisted by one piece or more pieces lenses have the same effective focal length fₙ which between 30 mm-300 mm. We definite that the distance between the axis of the laser rod in the said laser (n−1) and laser (n) is Lₙ₋₁, the distance between the center of laser spot on the said coupling output mirror (n4) and the said high reflectivity mirror (n2) is Lₙ₁, and the distance between the said lens (n7) and (n5) is Lₙ₆, then we obtain the equations:
Lₙ₋₁=4fₙ
Lₙ₁=L(ₙ₋₁₎1
Lₙ₆=2fₙ
Wherein L₍ₙ₋₁₎₁ is the distance between the center of laser spot on the said coupling output mirror ((n−1)4) and the said high reflectivity mirror ((n−1)2);
Wherein n and N are integers, and 1≦n≦N.

2. The method of claim 1, wherein the three high reflectivity mirrors (11, 12, 13) in step 1 whose reflectivity at the laser wavelength greater than 95% at 0° incidence; wherein mirror (11) and mirror (12) are placed in parallel, and the coated surface of the said mirrors face to the laser head (16), and the distance between them equals the equivalent plane-parallel resonator physical length, which generally between 200-800 cm, and the distances from the said mirror (11) and mirror (12) respectively to the center plane of laser rod end in laser head (16) are same.

3. The method of claim 1, wherein the lens (15) in step 1 composed of one piece or more pieces lenses, with effective focal length f₁ between 50-200 mm, is coated by antireflection film which reflectivity less than 1% at laser wavelength at 0° incidence.

4. The method of claim 1, wherein the laser head (16) in step 1 is an assembly comprising diode laser pumping source and laser crystal with neodymium or ytterbium doped.

5. The method of claim 1, wherein the coupling output mirror (14) in step 1 whose reflectivity at the laser wavelength between 10% and 50%, the distance L₁₁ between the center of laser spot on the said coupling output mirror (14) and the said high reflectivity mirror (12) is 20-380 mm. The distance L₁₂ between the said lens (15) and the center of laser spot on the said coupling output mirror (14) and the distance L₁₃ between the said high reflectivity mirrors (13) and the said lens (15) relate by: L₁₂=f₁-L₁₁ and L₁₃=f₁.
